(19) United States
(12) Patent Application Publication
(10) Pub. No.: US 2014/0207696 A1
(43) Pub. Date: Jul. 24, 2014

(54) SHARING PURCHASING INFORMATION

(71) Applicant: KT CORPORATION, Gyeonggi-do (KR)

(72) Inventors: Youn-Pil JEUNG, Gyeonggi-do (KR); Kook HEO, Seoul (KR); Sung-Chul KIM, Gyeonggi-do (KR)

(73) Assignee: KT CORPORATION, Gyeonggi-do (KR)

(21) Appl. No.: 14/161,934

(22) Filed: Jan. 23, 2014

(30) Foreign Application Priority Data
Jan. 23, 2013 (KR) 10-2013-0007304

(51) Int. Cl. G06Q 50/00; G06Q 20/32; G06Q 30/00

(52) U.S. Cl. CPC G06Q 50/01; G06Q 30/00; G06Q 20/3278
USPC 705/319

(57) ABSTRACT

The disclosure is related to sharing purchasing information among consumer using near field communication feature of user equipment. First user equipment may transfer purchasing information to second user equipment and the second user equipment may conveniently and instantly repurchase the same good or service, which the first user equipment purchases, based on the purchasing information.

### CROSS REFERENCE TO PRIOR APPLICATIONS

The present application claims priority under 35 U.S.C. §119 to Korean Patent Application No. 10-2013-0007304 (filed on Jan. 23, 2013), which is hereby incorporated by reference in its entirety.

### BACKGROUND

The present disclosure relates to sharing purchase information among consumers using near field communication (NFC) technology. A smartphone has various features including a near field communication (NFC) feature. Such NFC feature of the smartphone enables consumers to purchase goods or services from a merchant conveniently. For example, consumers can make a payment for purchasing goods or services using payment instruments stored in their smartphones (e.g., universal subscriber identity module (USIM) card) not only from stores but also from online shopping sites. After making the payment, the smartphone might digitally store the purchasing information or receive a digital receipt from the merchant.

### SUMMARY

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Embodiments of the present invention overcome the above disadvantages and other disadvantages not described above. Also, the present invention is not required to overcome the disadvantages described above, and an embodiment of the present invention may not overcome any of the problems described above.

In accordance with an aspect of the present embodiment, information on a purchased good may be shared with others using near field communication (NFC) features of user equipment.

In accordance with another aspect of the present invention, purchasing information may be conveniently transferred from one user equipment to the other using a NFC feature.

In accordance with still another aspect of the present invention, first user equipment may transfer purchasing information to second user equipment and the second user equipment can conveniently and instantly repurchase the same good or service, which the first user equipment purchases, based on the purchasing information.

In accordance with at least one embodiment, a method may be provided for sharing purchasing information by first user equipment using near field communication (NFC) feature. The method may include detecting a sharing operation initiation input and transferring at least one of purchasing information stored in the first user equipment to the second user equipment through a wireless communication link between the first user equipment and the second user equipment.

The detecting a sharing operation initiation input may include detecting the second user equipment located in a predetermined distance from the first user equipment and receiving a user input for initiating the sharing operation.

The detecting a sharing operation initiation input may include displaying a message for inquiring of an user of the first user equipment whether to transfer purchasing information, to receive purchasing information, or to ignore the detection of the sharing operation initiation input and performing the transferring at least one of purchasing information upon receipt of a user input for transferring purchasing information in response to the message.

The transferring at least one of purchasing information may include establishing a NFC communication link to the second user equipment, displaying a graphic user interface containing a list of stored purchasing information and enabling a user of the first user equipment to select at least one from the list, receiving a selection input from the user to select at least one from the list, and transferring the selected purchasing information to the second user equipment through the established NFC communication link.

The purchasing information may include information on at least one of a name of a merchant, a name of a good previously purchased by first user equipment, an uniform resource locator (URL) address of a web-site visited for purchasing the previously purchased good, an application used for purchasing the previously purchased good, an identification number of the previously purchased good, an associated purchasing date, an associated purchasing payment instrument, an associated approval number, an associated purchasing price, an associated unit price, and an associated number of units purchased.

Prior to the detecting a sharing operation initiation input, the method may further include detecting a storing operation initiation input and storing purchasing information of a good when the first user equipment is used to make a payment to purchase the good. The detecting a storing operation initiation input may include turning on the first user equipment, making a payment for purchasing a good using the first user equipment, and receiving an input for initiating the storing operation initiation input.

The storing purchasing information may include receiving information on a merchant and a purchased good from the merchant when the first user equipment makes a payment to purchase the good from the merchant, generating purchasing information of the purchased good based on the received information on the merchant and the purchased good, and storing the generated purchasing information in at least one of a memory of the first user equipment and a universal subscriber identity module (USIM) card of the first user equipment.

The method may include transmitting an incentive request with the purchasing information and information on the first and second user equipment to an associated server upon the transferring of the at least one of purchasing information stored in the first user equipment to the second user equipment and receiving a predetermined incentive from the associated server. The predetermined incentive may include a digital coupon for at least one of a discount, membership benefit points, and cashback points on next purchasing.

In accordance with at least one embodiment of the present invention, a method may be provided for sharing purchasing information by second user equipment using near field communication (NFC) feature. The method may include detecting a sharing operation initiation input and receiving at least one of purchasing information stored in first user equipment from the first user equipment through a wireless communication link between the first user equipment and the second user equipment and displaying the received at least one of purchasing information.

The detecting a sharing operation initiation input may include detecting the first user equipment located in a predetermined distance from the second user equipment and receiving a user input for initiating the sharing operation. The detecting a sharing operation initiation input may include displaying a message for inquiring of an user of the second user equipment whether to transfer purchasing information, to receive purchasing information, or to ignore the detection of the sharing operation initiation input and performing the receiving at least one of purchasing information upon receipt of a user input for receiving purchasing information in response to the message.

The receiving at least one of purchasing information may include establishing a NFC communication link to the first user equipment, receiving the at least one of purchasing information from the first user equipment, extracting merchant information and purchased good information from the received purchasing information, and displaying the extracted merchant information and the purchased good information.

After the receiving at least one of purchasing information, the method may include performing a repurchasing operation based on the displayed at least one purchasing information upon a predetermined event.

Prior to the performing a repurchasing operation, the method may further include extracting merchant information and purchased good information from the received at least one of purchasing information, determining one of a link of a web-site visited and an icon of an application used for purchasing an associated good based on the extracted merchant information and the extracted purchased good information, and displaying one of the determined link and the determined icon that initiates the repurchasing operation.

The performing a repurchasing operation may include selecting the associated good from the web-site or the application based on the extracted purchased good information and displaying a graphic user interface for repurchasing the selected good from one of the web-site and the application. The performing a repurchasing operation may include making a payment for repurchasing the selected good from one of the web-site and the application with information on one of payment instruments stored in a memory or a universal subscriber identity module (USIM) card of the second user equipment. After the performing a repurchasing operation, the method may further include transmitting an incentive request with the purchasing information and information on the first and second user equipment to an associated server upon initiation of the repurchasing operation at the second user equipment and receiving a predetermined incentive from the associated server.

### BRIEF DESCRIPTION OF THE DRAWINGS

The above and/or other aspects of the present invention will become apparent and more readily appreciated from the following description of embodiments, taken in conjunction with the accompanying drawings, of which:

FIG. 1 illustrates sharing purchasing information among consumers using user equipment in accordance with at least one embodiment;

FIG. 2 illustrates user equipment for sharing purchasing information in accordance with at least one embodiment;

FIG. 3 illustrates a method for sharing purchasing information among others in accordance with at least one embodiment; and

FIG. 4 illustrates a server of giving incentive to consumers if sharing purchasing information with others in accordance with at least one embodiment.

### DESCRIPTION OF EMBODIMENTS

Reference will now be made in detail to embodiments of the present invention, examples of which are illustrated in the accompanying drawings, wherein like reference numerals refer to like elements throughout. The embodiments are described below, in order to explain the present invention by referring to the figures.

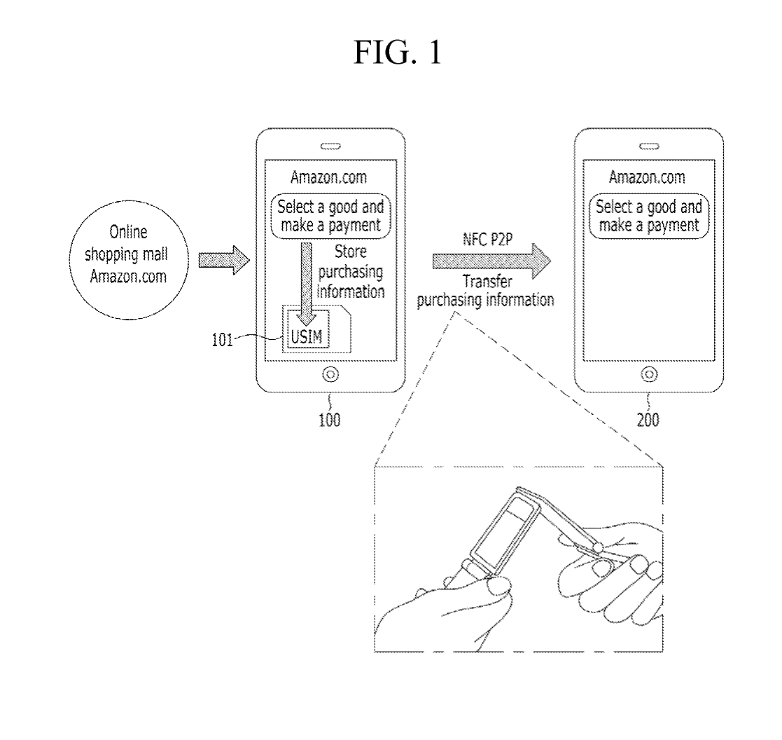

In accordance with at least one embodiment, purchasing information of a good may be transferred from first user equipment to second user equipment through near field communication (NFC). Based on the purchasing information, a user of the second user equipment may easily, conveniently, and instantly repurchase the same good or the same service purchased by a user of the first user equipment. Hereinafter, overall operation of sharing purchasing information will be described with reference to FIG. 1.

FIG. 1 illustrates user equipment for sharing purchasing information among consumers using user equipment having a NFC function in accordance with at least one embodiment. In accordance with at least one embodiment, one consumer may be enabled to conveniently share purchasing information on a good or a service among others using a near field communication (NFC) peer-to-peer (P2P) function of user equipment.

Referring to FIG. 1, such operation may be performed through user equipment having a NFC function. First user equipment 100 stores purchasing information on a good (or a service) and a merchant when an associated user (e.g., first consumer) purchases the good using first user equipment 100 from the merchant. Such stored purchasing information may be shared with others by transferring the stored purchasing information to other user equipment (e.g., second user equipment 200) through NFC feature. That is, first user equipment 100 may transfer at least one of purchasing information stored in a memory to second user equipment 200 upon the generation of a predetermined event or upon the receipt of a predetermined input.

First and second user equipment 100 and 200 may be electronic device having processing power and communication capability such as a NFC function. For example, first and second user equipment 100 and 200 may include a personal computer (PC), a smartphone, a laptop computer, a personal digital assistance (PDA), and a portable multimedia player (PMP). The present invention, however, is not limited thereto.

Such first user equipment 100 shares purchasing information with others (e.g., second user equipment 200) as follows. A first consumer purchases a good or a service using one of payment instruments stored in first user equipment 100. For example, the first consumer uses first user equipment 100 to purchase a camping stove from online shopping mall, Amazon.com or from a camping gear store located near to the first consumer's house. In this case, first user equipment 100 stores purchasing information on the camping stove in a predetermined secure sector of a memory of first user equipment 100 or a memory of a universal subscriber identity module (USIM) card included in first user equipment 100.

In accordance with at least one embodiment, the first consumer is enabled to transfer the stored purchasing information to others when the first consumer wants to recommend the good or the merchant to the others. For example, in order to recommend the purchased good to a second consumer having second user equipment 200, the first consumer controls first user equipment 100 to transfer the purchasing information of the purchased good to second user equipment 200 using a NFC function.

For example, the first consumer puts first user equipment 100 near to second user equipment 200 or makes contact of first user equipment 100 with second user equipment 200 for transferring the purchasing information of the purchased good from first user equipment 100 to second user equipment 200 in accordance with at least one embodiment. Then, second user equipment 200 displays the purchasing information transferred from first user equipment 100. Based on the purchasing information, the second consumer may easily recognize detail information on the purchased good of the first consumer and conveniently repurchase the same good from the same merchant.

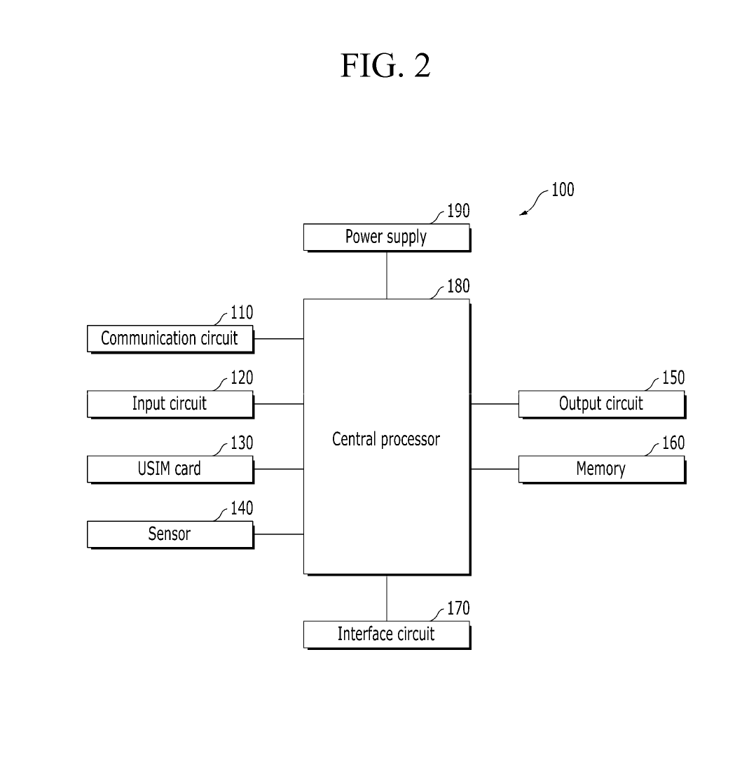

As described, first user equipment 100 transfers the purchasing information to second user equipment 200 using the NFC function. Such user equipment will be described in detail with reference to FIG. 2.

FIG. 2 illustrates user equipment having a NFC function for sharing purchasing information in accordance with at least one embodiment. Referring to FIG. 2, user equipment 100 includes communication circuit 110, input circuit 120, USIM card 130, sensor 140, output circuit 150, memory 160, interface circuit 170, central processor 180, and power supply 190.

Communication circuit 110 may include at least one module for communicating with other party through a wireless communication system. For example, wireless communication unit 110 may include any or all of a broadcasting signal receiving module, a mobile communication module, a wireless internet module, a short-distance communication module, and a location information module (e.g., GPS receiving module). The short-distance communication module may include a Bluetooth circuit, a radio frequency identification (RFID) circuit, an infrared data association (IrDA) circuit, an ultra-wideband (UWB) circuit, a Zigbee circuit, and a near field communication (NFC) module circuit. In accordance with at least one embodiment, such a short-distance communication module is used to transfer purchasing information from one user equipment to the other.

Input circuit 120 may be a user interface for receiving input (e.g., user commands) from a user. Input unit 120 may be realized in various types. For example, input unit 130 may include a touch screen, a keyboard and/or a keypad, a mouse device and/or a touchpad. Input unit 120 may further include a dome switch, a jog wheel, and a jog switch, but is not limited thereto. Particularly, with respect to the touch screen, user equipment 100 may be a full touch type smart phone. In this case, input unit 120 may include several hardware key buttons and a touch screen. The hardware key buttons may include a hold key and a volume control button. The touch screen may be disposed on an upper surface of output circuit 150, but the present invention is not limited thereto.

USIM card 130 may be an identification module circuit that stores information for authenticating a use right. In FIG. 2, USIM card 130 is illustrated as an identification module, but the present invention is not limited thereto. As the identification module, a user identify module (UIM) or a subscriber identity module (SIM) may be included in user equipment 100. USIM card 130 may be a smart card including a memory with a USIM module circuit in accordance with at least one embodiment. USIM card 130 may further include a NFC chip and may be referred to as a NFC USIM card. Such USIM card 130 may be coupled to user equipment 100 through interface circuit 170.

Sensor 140 may detect a current status of user equipment 100. Sensor 140 may include a variety of sensors such as a luminance sensor, an acceleration sensor, a gyro sensor, a proximity sensor, a contact sensor, and so forth. Based on the detected status of user equipment 100, sensor 140 may generate a sensing signal to control the operation of user equipment 100.

Output circuit 150 may be an output device for visually displaying information. For example, output circuit 150 may display image data produced or processed by central processor 180. Output unit 150 may receive the image data from central processor 180 and display the received image data. The image data may be produced as a result of certain operations performed by any software programs installed in user equipment 100. For example, the image data may be data processed for displaying a graphic user interface produced by an operation system and applications, performed in user equipment 100. The applications may be referred to as “App”. Also, the image data may further include still images and moving images, produced or processed by central processor 180. For example, output circuit 150 may be a liquid crystal display (LCD) panel or an active-matrix organic light-emitting diode (AMOLED) panel, but the present invention is not limited thereto.

For example, output circuit 150 may display a list of purchasing information stored in memory 160 in order to enable a user to select at least one of purchasing information to transfer to others. Furthermore, output circuit 150 may display purchasing information received from other through communication circuit 110. In addition, output circuit 150 may further include output devices for outputting auditory sensing information and haptic sensing information. For example, output circuit 150 may include a speaker, an alarm circuit, and a haptic circuit.

Memory 160 may be used as a data storage device of user equipment 100. Memory 160 may store information necessary for operating user equipment 100 and performing certain operations requested by a user. Such information may include any software programs and related data. Memory 160 may be a flash memory, hard disk, multimedia card micro memory, SD or XD memory, Random Access Memory (RAM), Static Random Access Memory (SRAM), Read-Only Memory (ROM), Programmable Read-Only Memory (PROM), Electrically Erasable Programmable Read-Only Memory (EEPROM), magnetic memory, magnetic disk, or optical disk, but is not limited thereto.

In accordance with at least one embodiment, memory 160 stores purchasing information on a good purchased using user equipment 100. Particularly, a predetermined secure section of memory 160 stores the purchasing information. When a consumer purchases a good using user equipment 100 from a merchant (e.g., an online shopping mall or a store), user equipment 100 stores the purchasing information in memory 160. The purchasing information may include information on the merchant and information of the purchased good. The merchant information may include a merchant name, a uniform resource locator (URL) address, an application used for purchasing the good, a discount offered, and so forth. The purchased good information may include a name of the purchased good, a date, an identification number, a price, a purchasing condition, and so forth. User equipment 100 may generate such purchasing information based on information obtained from the merchant or from the purchased good. Alternatively, user equipment 100 may receive such purchasing information from the merchant (e.g., a server of an online shopping mall or a payment terminal or a server of the merchant). Although memory 160 is described to store the purchasing information, the present invention is not limited thereto. Such purchasing information may be stored in a memory of a USIM card included in user equipment 100. Such USIM card may support a NFC USIM card that supports NFC.

Interface circuit 170 may include at least one port for exchanging signals and/or data with others. Interface circuit 170 receives data or power from external devices and delivers the received data or power to constituent elements in user equipment 100. Furthermore, interface circuit 170 transmits data to external devices. For example, interface circuit 170 may include a wired/wireless headset port, a power charge port, a wired/wireless data port, a memory card port, and a port coupled to an identification module.

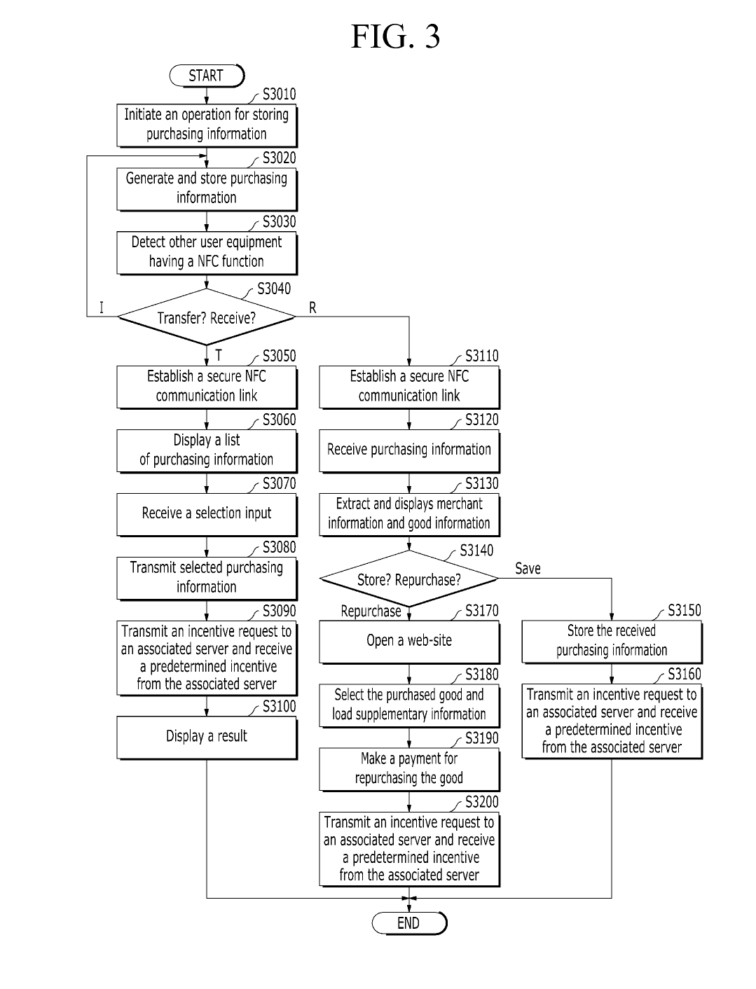

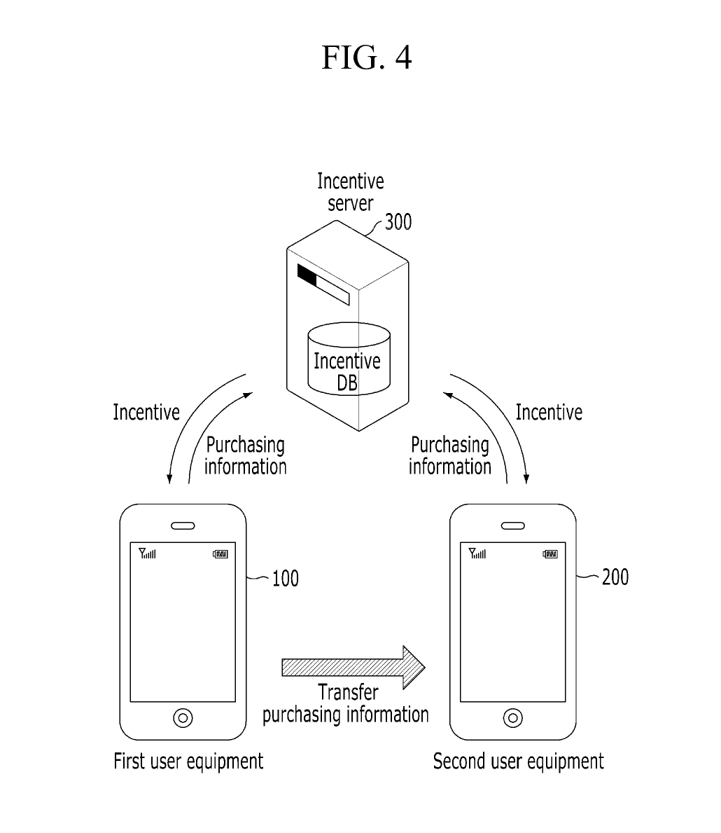

Central processor 180 may control overall operation of the constituent elements of user equipment 100. Particularly, controller 180 may perform operations necessary for driving the constituent elements of user equipment 100 in response to inputs received from a related user. In accordance with at least one embodiment, central processor 180 may perform operations related to share purchasing information to others. Such operation of central processor 180 will be described in detail with reference to FIG. 3 and FIG. 4. Power supply 190 may supply power to constituent elements in response to control of central processor 180.

As described, first user equipment 100 transfers predetermined purchasing information to second user equipment 200 using a NFC function in accordance with at least one embodiment. Such operation for sharing purchasing information may be performed by a predetermined application installed in and executed by user equipment. Such operation of user equipment will be described in reference to FIG. 3.

FIG. 3 illustrates a method for sharing purchasing information among consumers in accordance with at least one embodiment.

Referring to FIG. 3, an operation for storing purchasing information is initiated upon the generation of a predetermined event at step S3010. For example, the operation for sharing purchasing information may be initiated upon various types of events. The events may include turning on user equipment 100, making a payment for purchasing a good using user equipment 100, receiving an input for selecting (e.g., clicking) an associated icon or button from a user, activating a NFC function, and so forth. Such event may be set by at least one of a user, a system designer, or a service provider. When the operation for sharing purchasing information is performed by an application installed in and executed by user equipment 100, such operation may be activated by selecting and clicking an associated icon displayed within a default graphic user interface of user equipment 100.

At step S3020, purchasing information is generated and stored upon a predetermined event. Purchasing information may be generated and stored whenever user equipment 100 is used to purchase a good. For example, a first consumer purchases a good (e.g., camping stove) from an online shopping mall (e.g., amazon.com) using first user equipment 100. The first consumer activates a web-browser installed in first user equipment 100, opens a web-site of amazon.com (www.amazon.com), and purchases the camping stove from the online shopping mall, amazon.com. The present invention, however, is not limited thereto. The first consumer may activate a mobile application (e.g., APP) downloaded from a server of amazon.com and installed in first user equipment 100 and purchase the camping stove from the activated application. In addition, the first user equipment may purchase the camping stove from a typical store such as Walmart using first user equipment 100. In this case, the first consumer may touch first user equipment 100 at a payment terminal located at Walmart or put first user equipment 100 near to the payment terminal for making a payment for purchasing the camping stove through a NFC communication link established between first user equipment 100 and the payment terminal.

Whenever the consumer uses user equipment 100 to purchase a good, user equipment 100 generates the purchasing information of the purchased good and stored in user equipment 100. For example, after purchasing the good (e.g., the camping stove), first user equipment 100 may receive information of the purchased good (e.g., the camping stove) and the merchant (e.g., Amazon.com) from the server of Amazon.com. Based on the received information, user equipment 100 may generate purchasing information and stored in at least one of memory 150 and NFC USIM card 130. The received information may be a receipt of the purchased good, received from the merchant. Furthermore, such received information may be used as the purchasing information without modifying or adding more information. In this case, user equipment 100 stores the received receipt as the purchasing information.

The purchasing information may include merchant information and purchased good information. For example, the purchasing information may include information on an Internet address (e.g., URL address) of merchant, information on an mobile application, an identification number of a purchased good, a purchasing date, a merchant name, a purchasing method, an approval number, a purchasing price, a good name, a unit price, a number of units, and so forth. Such purchasing information may be used as a mobile receipt.

Although the purchasing information was described as automatically generated or received, the present invention is not limited thereto. User equipment 100 may enable a user to enter the purchasing information of a predetermined good although user equipment 100 is not used to purchase the predetermined good. In this case, user equipment 100 may display a graphic user interface that enables a user to enter purchasing information of the predetermined good in response to a user input.

At step S3030, a predetermined event for initiating an operation for sharing purchasing information is detected and an inquiry message may be displayed. For example, when user equipment 100 detects other user equipment having a NFC feature located in a predetermined distance, user equipment 100 initiates the operation for sharing purchasing information. Alternatively, when user equipment 100 receives a user input that initiates the operation for sharing purchasing information, user equipment 100 initiates the operation for sharing purchasing information.

Upon the detection of the predetermined event, user equipment 100 displays a message for inquiring a user whether to transfer the purchasing information, to receive the purchasing information, or to ignore such detection. Then, user equipment 100 may wait for user inputs.

At step S3040, upon the receipt of the user input, determination may be made so as whether the received user input is for transferring purchasing information, for receiving purchasing information, or for ignoring the detection of the user input. For example, in response to the inquiry message, user equipment 100 receives user inputs for transferring purchasing information, for receiving purchasing information, or for ignoring the detected event.

In case for ignoring the detected event (I-S3040), user equipment 100 continuously performs operation for generating and storing purchasing information whenever user equipment 100 is used for purchasing a good at step S3020.

In case for transferring purchasing information (T-S3040), a communication link is established between first user equipment 100 and detected user equipment (e.g., second user equipment 200) based on a NFC function at step S3050. For example, first user equipment 100 establishes a NFC secure communication link to second user equipment 200. An authentication procedure may be performed additionally based on NFC specification.

At step S3060, a list of stored purchasing information is displayed. For example, first user equipment 100 displays a graphic user interface containing a list of purchasing information stored in memory 160 or NFC USIM card 130. Such a graphic user interface also enables a user to select at least one of purchasing information in the list.

At step S3070, a selection input is received. For example, first user equipment 100 receives a user selection input for selecting at least one of purchasing information in the displayed list.

At step S3080, one of purchasing information is selected and transmitted in response to the received selection input. For example, first user equipment 100 selects one of purchasing information in the list in response to the received selection input and transmits the selected purchasing information to second user equipment 200 through the established NFC communication line.

At step S3090, an incentive request may be transmitted to an associated server and a predetermined incentive may be received from the associated server. For example, first user equipment 100 generates the incentive request to include the transferred purchasing information, the associated payment information, and information on the second user equipment 200. First user equipment 100 transmits the generated incentive request to the associated server. In response to the incentive request, the associated server may transmit a predetermined incentive to first user equipment 100. First user equipment 100 receives the predetermined incentive and stores the received incentive in a memory thereof. Such incentive may be a digital coupon for discount, bonus points, or cashback points. Furthermore, the incentive may have a value different according to an event: transferring, saving, and repurchasing. That is, an incentive having a comparatively greater value is given to the event of repurchasing a good based on the shared purchasing information. Furthermore, an incentive having a comparatively lower value is given to the event of transferring or saving purchasing information. Such operation will be described in more detail with reference to FIG. 4.

At step S3100, a result of transferring the selected purchasing information is displayed. For example, after transmitting the selected purchasing information, first user equipment 100 displays a message for showing a result thereof.

In case for receiving purchasing information (R-S3040), a NFC communication link is established between first user equipment 100 and detected second user equipment 200 based on a NFC feature at step S3110. For example, first user equipment 100 establishes a secure NFC communication link to second user equipment 200. An authentication procedure may be performed additionally based on NFC specification.

At step S3120, the transferred purchasing information is received. For example, second user equipment 200 receives purchasing information from first user equipment 100. As described, the received purchasing information includes information on merchant information, purchased good information, and user equipment information.

At step S3130, merchant information and purchased good information are extracted from the received purchasing information and displayed. For example, second user equipment 200 extracts the merchant information and the purchased good information from the received purchasing information. Second user equipment 200 displays the extracted merchant information and purchased good information. In addition, second user equipment 200 displays a link or an icon that initiates a repurchasing operation with the extracted information.

At step S3140, determination is made whether a user input is for storing the received purchasing information or for initiating a repurchasing operation. For example, when second user equipment 200 receives a user input after displaying the received purchasing information, second user equipment 200 determines whether the received user input is for storing the received purchasing information or for initiating a repurchasing operation.

When the received user input is for storing the received purchasing information (Save-S3140), the received purchasing information is saved at step S3150. For example, second user equipment 200 stores the received purchasing information in a memory thereof. Such stored purchasing information may be used for repurchasing the same good at a desired time of a user of second user equipment 200. Whenever the user of second user equipment 200 selects the stored purchasing information, the stored purchasing information is displayed with a link or an icon initiating the repurchasing operation.

At step S3160, an incentive request may be transmitted to an associated server and a predetermined incentive may be received from the associated server. For example, second user equipment 200 generates the incentive request to include the received purchasing information and information on first user equipment 100. Second user equipment 200 transmits the generated incentive request to the associated server. In response to the incentive request, the associated server may transmit a predetermined incentive to second user equipment 200. Second user equipment 200 receives the predetermined incentive and stores the received incentive in a memory thereof. Since this is the saving event, second user equipment 200 may receive an incentive having a comparatively lower value.

When the received user input is for initiating a repurchasing operation (Repurchase-S3140), an application used for purchasing the good is activated or a web-site visited for purchasing the good is opened based on the purchasing information at step S3170. For example, second user equipment 200 determines an application used or a web-site visited by first user equipment 100 for purchasing the good based on the received purchasing information. Based on the determination, second user equipment 200 may activate the determined application of the merchant or open the determined web-site of the merchant.

At step S3180, the purchased good is selected from the activated application or from the opened website and supplementary purchasing information is entered based on the purchasing information. For example, after activating the application or opening the web-site, second user equipment 200 may automatically select the good purchased by first user equipment 100 from the activated application or from the opened website based on the purchasing information. Furthermore, second user equipment 200 may automatically load supplementary information required by the activated application or by the opened web-site for repurchasing the good based on information stored in second user equipment 200. Such supplementary information may be obtained from a memory of second user equipment 200 or from a USIM card of second user equipment 200. The supplementary information may include information on second user equipment 200 and payment instruments stored in second user equipment 200.

When a user input for confirming the selection of the good and the entered information, user equipment 200 makes a payment for repurchasing the selected good at step S3190. As described, a user of second user equipment 200 does not need to select or to enter information for repurchasing a good recommended by a user of first user equipment 100. Accordingly, consumers can instantly and conveniently repurchase a good based on the shared purchasing information.

At step S3200, an incentive request may be transmitted to an associated server and a predetermined incentive may be received from the associated server. For example, second user equipment 200 generates the incentive request to include the received purchasing information, the associated payment information, and information on first user equipment 100. Second user equipment 200 transmits the generated incentive request to the associated server. In response to the incentive request, the associated server may transmit a predetermined incentive not only to second user equipment 200 but also to first user equipment 100. Second user equipment 200 and first user equipment 100 receive the predetermined incentive and stores the received incentive in a memory thereof. Since this is the repurchasing event, first user equipment 100 and second user equipment 200 may receive an incentive having a comparatively greater value.

As described, through transferring purchasing information from one user equipment to the other, consumers can conveniently and instantly repurchase goods or services, which are previously purchased and recommended by others, in accordance with at least one embodiment. Such sharing purchasing information might increase earnings of merchants or manufacturers. Accordingly, a server might offer consumers predetermined incentive when the consumers share purchasing information. Hereinafter, such a server for encouraging more consumers to share their purchasing information with others will be described with reference to FIG. 4.

FIG. 4 illustrates a server of giving incentive to consumers if sharing purchasing information with others in accordance with at least one embodiment.

Referring to FIG. 4, server 300 is coupled to first user equipment 100 and second user equipment 200 through a communication network. First user equipment 100 and second user equipment 200 share purchasing information by transferring the purchasing information to others through NFC. Server 300 give predetermined incentive to user equipment if the user equipment shares purchasing information or repurchase a good based on the shared purchasing information.

When first user equipment 100 transfers purchasing information to second user equipment 200, first user equipment 100 may transmit an incentive request with the transferred purchasing information, associated payment information, and information on second user equipment 200 to server 300. The payment information associated with the transferred purchasing information may include information on a consumer, identification, and a price.

Server 300 receives the incentive request from user equipment and gives a predetermined incentive to the user equipment in accordance with at least one embodiment. Server 300 may be a computing system of a service provider or a predetermined merchant. The predetermined incentive may include a discount offer, a cash back offer, a bonus point offer, and so forth. That is, in response to the incentive request, server 300 transmits a digital coupon for discount, cash back, or bonus point to the user equipment.

Server 300 may include an incentive database (DB) for storing and managing purchasing information, payment information, user equipment information, and associated incentive information. For example, server 300 receives shared purchasing information, associated payment information, and second user equipment information from first user equipment 100, gives predetermined incentive to first user equipment 100, and stores the received shared purchasing information, the received associated payment information, the received second user equipment information, and the incentive information in the incentive DB in connection with information on first user equipment 100.

In addition, server 300 may give predetermined incentive to consumers who repurchase a good based on the shared purchasing information. For example, after receiving purchasing information from first user equipment 100, second user equipment 200 displays the received purchasing information. When second user equipment 200 repurchases a good based on the displayed purchasing information, second user equipment 200 transmits an incentive request to sever 300 with the received purchasing information, the payment information, and the first user equipment information. In response to such request, server 300 gives predetermined incentive not only to second user equipment 200 but also to first user equipment 100 in accordance with at least one embodiment.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The present invention can be embodied in the form of methods and apparatuses for practicing those methods. The present invention can also be embodied in the form of program code embodied in tangible media, non-transitory media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

No claim element herein is to be construed under the provisions of 35 U.S.C. §112, sixth paragraph, unless the element is expressly recited using the phrase “means for” or “step for.”

Although embodiments of the present invention have been described herein, it should be understood that the foregoing embodiments and advantages are merely examples and are not to be construed as limiting the present invention or the scope of the claims. Numerous other modifications and embodiments can be devised by those skilled in the art that will fall within the spirit and scope of the principles of this disclosure, and the present teaching can also be readily applied to other types of apparatuses. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method of sharing purchasing information by first user equipment using near field communication (NFC) feature, the method comprising:
detecting a sharing operation initiation input; and
transferring at least one of purchasing information stored in the first user equipment to second user equipment through a wireless communication link between the first user equipment and the second user equipment.

2. The method of claim 1, wherein the detecting a sharing operation initiation input includes:
detecting the second user equipment located in a predetermined distance from the first user equipment; and
receiving a user input for initiating a sharing operation.

3. The method of claim 1, wherein the detecting a sharing operation initiation input includes:
displaying a message for inquiring of an user of the first user equipment whether to transfer purchasing information, to receive purchasing information, or to ignore the detection of the sharing operation initiation input; and
performing the transferring at least one of purchasing information upon receipt of a user input for transferring purchasing information in response to the message.

4. The method of claim 1, wherein the transferring at least one of purchasing information includes:
establishing a NFC communication link to the second user equipment;
displaying a graphic user interface that contains a list of stored purchasing information and enables a user of the first user equipment to select at least one from the list;
receiving a selection input from the user to select at least one from the list;
transferring the selected purchasing information to the second user equipment through the established NFC communication link.

5. The method of claim 1, wherein the purchasing information includes information on a name of a merchant, a name of a purchased good, an uniform resource locator (URL) address of a web-site visited for purchasing the purchased good, an application used for purchasing the purchased good, an identification number of the purchased good, a purchasing date, a purchasing payment instrument, an approval number, a purchasing price, a unit price, and a number of units purchased.

6. The method of claim 1, prior to the detecting a sharing operation initiation input, comprising:
detecting a storing operation initiation input; and
storing purchasing information of a good when the first user equipment is used to make a payment to purchase the good.

7. The method of claim 6, wherein the detecting a storing operation initiation input includes:
turning on the first user equipment;
making a payment for purchasing a good using the first user equipment; and
receiving a user input for initiating a storing operation.

8. The method of claim 6, wherein the storing purchasing information includes:
receiving information on a merchant and a purchased good from the merchant when the first user equipment makes a payment to purchase the good from the merchant;
generating purchasing information of the purchased good based on the received information on the merchant and the purchased good; and
storing the generated purchasing information in at least one of a memory of the first user equipment and a universal subscriber identity module (USIM) card of the first user equipment.

9. The method of claim 1, comprising:
transmitting an incentive request with the purchasing information and information on the first and second user equipment to an associated server upon the transferring of the at least one of purchasing information stored in the first user equipment to the second user equipment and
receiving a predetermined incentive from the associated server.

10. The method of claim 9, wherein the predetermined incentive includes a digital coupon for at least one of a discount, membership benefit points, and cashback points on next purchasing.

11. A method of sharing purchasing information by second user equipment using near field communication (NFC) feature, the method comprising:
detecting a sharing operation initiation input;
receiving at least one of purchasing information stored in first user equipment from the first user equipment through a wireless communication link between the first user equipment and the second user equipment; and
displaying the received at least one of purchasing information.

12. The method of claim 11, wherein the detecting a sharing operation initiation input includes:
detecting the first user equipment located in a predetermined distance from the second user equipment; and
receiving a user input for initiating the sharing operation.

13. The method of claim 11, wherein the detecting a sharing operation initiation input includes:
displaying a message for inquiring of an user of the second user equipment whether to transfer purchasing information, to receive purchasing information, or to ignore the detection of the sharing operation initiation input; and
performing the receiving at least one of purchasing information upon receipt of a user input for receiving purchasing information in response to the message.

14. The method of claim 11, wherein the receiving at least one of purchasing information includes:
establishing a NFC communication link to the first user equipment;
receiving the at least one of purchasing information from the first user equipment;
extracting merchant information and purchased good information from the received purchasing information; and
displaying the extracted merchant information and the purchased good information.

15. The method of claim 14, wherein the extracted merchant information and the extracted purchased good information includes information on at least one of a name of a merchant, a name of a good purchased by the first user equipment, an uniform resource locator (URL) address of a web-site visited by the first user equipment for purchasing the purchased good, an application used by the first user equipment for purchasing the purchased good, an identification number of the purchased good, a purchasing date, a purchasing payment instrument, an approval number, a purchasing price, a unit price, and a number of units purchased.

16. The method of claim 11, after the receiving at least one of purchasing information, comprising:
performing a repurchasing operation based on the displayed at least one purchasing information upon a predetermined event.

17. The method of claim 16, prior to the performing a repurchasing operation, comprising:
extracting merchant information and purchased good information from the received at least one of purchasing information;
determining one of a link of a web-site visited and an icon of an application used by the first user equipment for purchasing an associated good based on the extracted merchant information and the extracted purchased good information; and
displaying one of the determined link and the determined icon that initiates the repurchasing operation.

18. The method of claim 17, wherein the performing a repurchasing operation includes:
selecting the associated good from the web-site or the application based on the extracted purchased good information; and
displaying a graphic user interface for repurchasing the selected good from one of the web-site and the application.

19. The method of claim 17, wherein the performing a repurchasing operation includes:
making a payment for repurchasing the selected good from one of the web-site and the application with information on one of payment instruments stored in a memory or a universal subscriber identity module (USIM) card of the second user equipment.

20. The method of claim 16, after the performing a repurchasing operation, comprising:
transmitting an incentive request with the purchasing information and information on the first and second user equipment to an associated server upon initiation of the repurchasing operation at the second user equipment; and
receiving a predetermined incentive from the associated server.
